(19) United States
(12) Patent Application Publication
(10) Pub. No.: US 2008/0212151 A1
(43) Pub. Date: Sep. 4, 2008

(54) Rain Sensor, for a Motor Vehicle in Particular, and Method for Producing the Rain Sensor

(76) Inventors: Frank Wolf, Buehl (DE); Vladislav Matusevich, Jena (DE); Richard Kowarschik, Schleiz (DE); Karim Haroud, Chavannes sur Moudon (CH); Andreas Pack, Haguenau (DE)

Correspondence Address: MICHAEL J. STRIKER, 103 EAST NECK ROAD, HUNTINGTON, NY, 11743, US

(21) Appl. No.: 11/912,167

(22) PCT Filed: Nov. 8, 2006
(86) PCT No.: PCT/EP2006/068223

§ 371 Date: Oct. 22, 2007

(30) Foreign Application Priority Data
Dec. 28, 2005 (DE) 10 2005 062 785.4

(51) Int. Cl. G02B 5/32; G03H 1/08; B29D 11/00; G02B 6/34

(52) U.S. Cl. 359/15; 430/2; 264/1.25

(57) ABSTRACT

The invention relates to a rain sensor, especially for a motor vehicle, said sensor comprising an optical waveguide (22) which can be arranged in a windscreen. According to the invention, the planar holographic coupling elements for coupling and decoupling radiation (4) are formed from layered photo-polymer parts (3) into which volume holograms are integrated. The photo-polymer parts (3) are arranged between the core (1) of the waveguide and the envelope of the waveguide (2), resulting in a simple production method and an increased flexibility in terms of the arrangement of the waveguide (22) in the windscreen.

### RELATED ART

The present invention relates to a rain sensor, for a motor vehicle in particular, with an optical waveguide that may be located in a pane, and which includes a waveguide core, a waveguide clad, and planar holographic coupling elements for coupling and decoupling radiation. The present invention also relates to a method for generating a volume hologram in a holographic coupling element composed of photopolymer for a rain sensor, and a method for manufacturing a rain sensor.

A rain sensor of this type, which functions according to the principle of total reflection, is made known in DE 102 29 239 A1. While conventional sensors couple the light into the windshield, which is used as a waveguide, the known rain sensor uses an additional optical waveguide, in which the light propagates from a transmission/receiving region—which may be positioned in the pane, at its edge, or even outside thereof—to the vicinity of a detection region located in the wiping field of the windshield wipers, and back. It is also known to use planar holographic coupling elements. The decoupling element may be designed as a volume hologram. With the known rain sensor, the optical waveguide is located in an adhesive intermediate layer of the pane. The cladding of the waveguide includes openings in the region of the coupling elements. It is provided to realize this by designing the clad layer as a continuous layer, which, e.g., via photolithografic processes, takes on the characteristic of holograms with the desired coupling and decoupling properties.

Publication DE 197 01 258 A1 makes known many different designs of planar coupling elements for conventional rain sensors, i.e., without optical waveguides. A holographic phase grating, for example, may also be formed, in particular, using a volume hologram with a photopolymer as the carrier material. It is mentioned that volume holograms may be incorporated in foils composed of photopolymers, but no further details are provided regarding the generation of the holograms or rain sensors, or regarding the joining/positioning of the photopolymeric carrier material with the pane.

The inventive rain sensor as recited in claim 1 has the advantage that the coupling elements are formed by lamellar pieces composed of photopolymer, into which the volume holograms are incorporated, and that the photopolymer pieces are located between the waveguide core and the waveguide clad. In this manner, economical coupling means with very good coupling behavior are obtained, which may be easily integrated in the optical waveguide of the rain sensor. A design of this type also provides various possibilities for embedding the optical waveguide equipped with the photopolymer pieces in a pane. The same (or similar) holographic grating may be used for the coupling and decoupling. Since volume holograms are used, the risk of surface contaminations that exists with relief structures is eliminated.

In terms of manufacturability, it is advantageous to locate the optical waveguide equipped with the photopolymer pieces in a laminated glass pane, between a glass layer and an adhesive intermediate layer. In principle, the optical waveguide with the photopolymer pieces may also be located in the intermediate layer.

In a particularly advantageous embodiment, the photopolymer includes a polymer matrix composed of a polymethylmethacrylate (PMMA=acrylic glass). This versatile, economic plastic combines high optical quality—in particular, precise holographic phase gratings may be produced therein—with good workability. After the holograms are developed, the photopolymer becomes transparent, i.e., it does not interfere with the driver's field of view.

In an advantageous design of the rain sensor, the U-type, a first and second photopolymer piece are located—with separation between them—in a line that extends perpendicularly to the direction of propagation in the optical waveguide and parallel to the pane; the first coupling element decouples the radiation toward a detection region, and the second coupling element couples the radiation back into the waveguide, so that it may propagate toward the receiving region. One requirement for this design is that the volume holograms be very precise.

In an alternative design, the axis-type, two photopolymer pieces designed for coupling and decoupling are located one in front of the other along the direction of propagation in the optical waveguide. The axis-type sensor has the advantage that a relatively wide light beam may be used, thereby resulting in an advantageous enlargement of the detection region.

The inventive method for generating a volume hologram in a holographic coupling element composed of photopolymer for a rain sensor, in particular for an inventive rain sensor, makes it easily possible to generate precise interference patterns for volume holograms, in acrylic glass in particular. The steps are:
Provide a photopolymer composed of a polymer matrix and photosensitive molecules,
Holographically expose the photopolymer according to a specified spacially periodic pattern of exposed and unexposed regions; via polymerization of a portion of the photosensitive molecules, a first modulation of the refractive index corresponding to the regions is formed, which is partially compensated for by a second modulation of the refractive index formed by non-polymerized, photosensitive molecules,
Develop the exposed photopolymer by heating, the heating being carried out such that, due to a spacially homogenizing diffusion of photosensitive molecules from the unexposed regions into the exposed regions, the second modulation is reduced or eliminated, and, therefore, an interference pattern formed by the modulations is enhanced,
Fix the interference pattern formed via exposure and/or heat treatment, in order to thereby produce a volume hologram in the photopolymer.

The inscription of the holograms may therefore be carried out, according to the present invention, using simple and economical holographic methods, in particular using common laser light sources. The photopolymer, which is composed of the polymer matrix and a photosensitive monomer, requires no chemical development. Instead, development and fixation are accomplished via heating, e.g., using a halogen lamp.

A method for manufacturing an inventive rain sensor is described in dependent Claims 8 through 10.

Exemplary embodiments of the present invention are explained in greater detail below with reference to the schematic figures in the drawing.

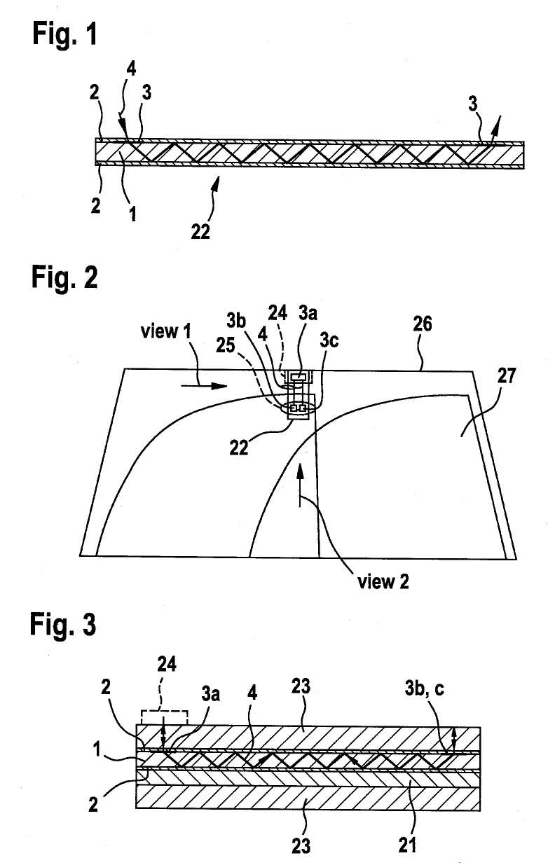

FIG. 1 shows a cross section through an optical waveguide with photopolymer pieces, which may be used for an inventive rain sensor,

FIG. 2 shows a top view of a pane with an inventive, U-type rain sensor,

FIG. 3 shows a cross section in a first direction through the design shown in FIG. 2,

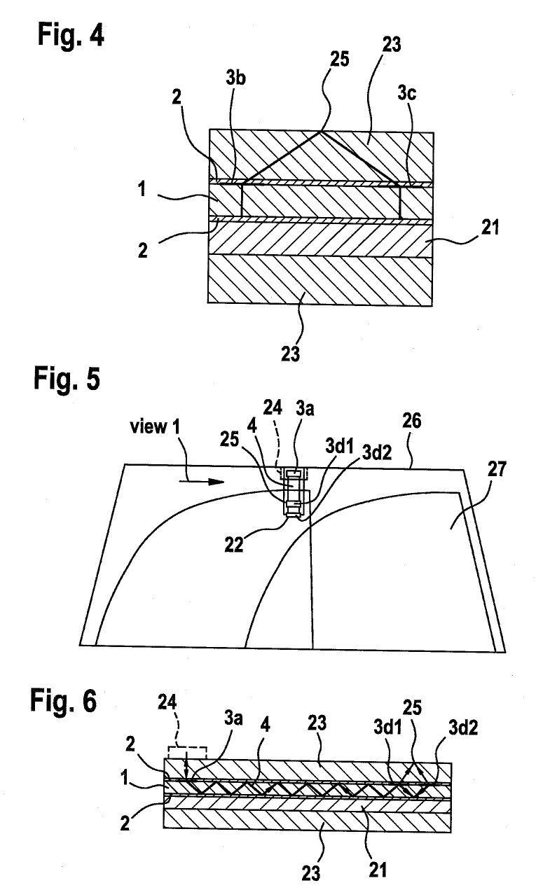

FIG. 4 shows a cross section in a second direction through the design shown in FIG. 2,

FIG. 5 shows a top view of a pane with an inventive, axis-type rain sensor,

FIG. 6 shows a cross section through the design shown in FIG. 5,

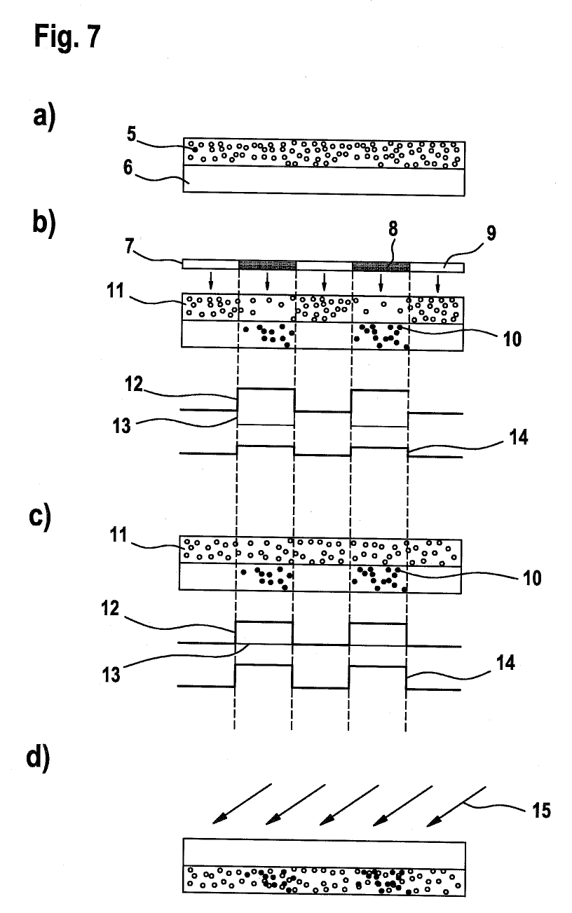

FIG. 7 shows the steps a) through d) of the inventive method for generating a volume hologram in a holographic coupling element composed of photopolymer for a rain sensor,

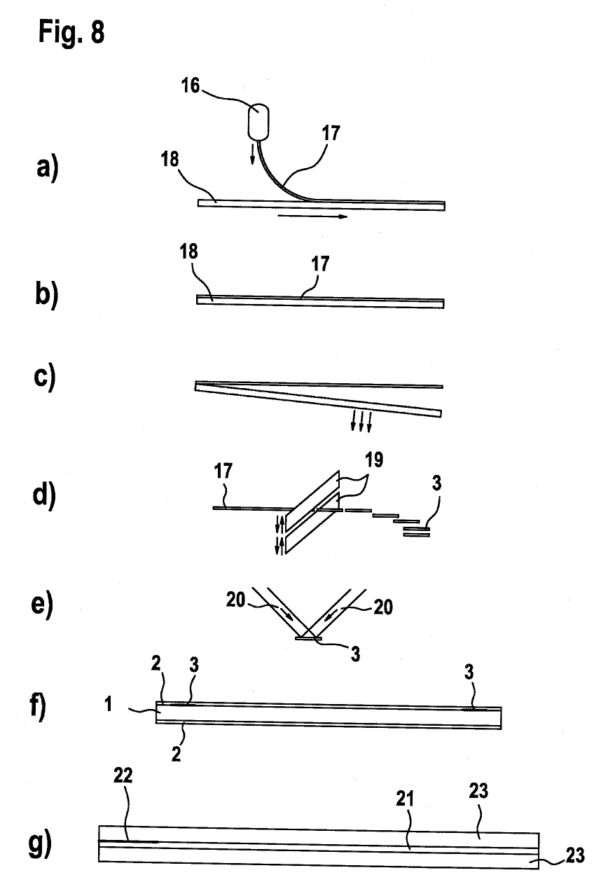

FIG. 8 depicts steps a) through g) of a method for manufacturing an inventive rain sensor.

FIG. 1 show an optical waveguide 22, which is intended for use with a rain sensor and has not yet been installed in a pane, which includes a waveguide core 1 and a waveguide clad 2 composed—ideally—of a transparent, dielectric material. Core 1 may be composed, e.g., of glass, and may have a thickness in the range of 200 μm, while coating 2 is typically 5 to 10 μm thick. A light beam 4—which is generated by components of the rain sensor that are not shown in FIG. 1—is coupled into optical waveguide 22 and propagates to an intended point, at which beam 4 is decoupled using coupling element 3, i.e., it is deflected in a certain direction. In a rain sensor, light beam 4 is typically deflected to a detection region on the outermost surface of the pane, where it is completely reflected, provided the pane is not wetted with raindrops, so that light beam 1 may be coupled back into optical waveguide 22, propagate therein, and ultimately be decoupled toward a receiving element of the rain sensor. The weakening of light beam 4 due to partial decoupling at a detection region wetted with moisture may be utilized in a manner known per se to generate the desired sensor signal. An optical waveguide 22 of this type may have, e.g., a width of 5 cm and a length of 20 cm or more, so that the transmission/receiving region of the sensor may be a greater distance away from the detection region without the sensor having to rely on using the pane itself as an optical waveguide.

Holographic coupling elements 3, which are selected for precise coupling and decoupling, are composed of photopolymer pieces 3, which typically have a size of 2×2 mm or more, and a thickness of 5 to 10 μm. Since photopolymer pieces 3 are located between core 1 and clad 2 of waveguide 22, the surface of the waveguide—in deviation from the schematic depiction in FIG. 1—may be arched at that point in the manner of a bulge, which is not a problem with the given dimensions and materials. In addition, optical waveguide 22—as described in greater detail below—is typically embedded in a laminated glass pane. The adhesive, elastic PVB intermediate layer may assume or compensate for the shape of waveguide 22, in particular for the shape of the bulge.

FIG. 2 shows a front pane 26 of a motor vehicle with a wiping region 27, which is passed over by (not shown) windshield wipers, and a U-type rain sensor located in the center at the upper edge of pane 26. The rain sensor includes a transmission/receiving region 24 located outside of the driver's field of view, and a detection region 25', which is located in wiping field 27. The U-shaped structure of the sensor is shown; it includes a photopolymer piece 3a, which is suitable for coupling and decoupling, serves as the “base”, and couples and decouples radiation 4 from transmission/receiving region 24 into waveguide 22. Furthermore, two “U legs” are provided, which are formed by a light beam 4 propagating in waveguide 22 from photopolymer piece 3a to a further photopolymer piece 3b, and by a beam 4 propagating from a coupling third photopolymer piece 3c back to the “base”.

FIG. 3 shows a cross section of the rain sensor shown in FIG. 2, in the first sectional view (view 1) indicated there. Transmission/receiving region 24 is located on (the outside in FIG. 3, to simplify the depiction) a laminated glass pane 26, which is composed of an inner and outer glass layer 23, which are held together by an adhesive intermediate layer 21, which is preferably composed of PVB (polyvinyl butyral). Optical waveguide 22, which is depicted in FIG. 1 and is composed of a glass core 1, clad layer 2, and holographic coupling elements 3 made of photopolymer, is located between intermediate layer 21 and a glass layer 23.

The mode of operation of the U-type rain sensor is best explained with reference to FIG. 3 in combination with the sectional view of the sensor shown in FIG. 4 (see FIG. 2, view 2). Starting at transmission/receiving region 24, light beam 4 is coupled by photopolymer piece 3a into waveguide 22, and propagates to decoupling element 3b in waveguide 22, from which point beam 4 is deflected to a detection region 25 located on the outside of pane 26. There, beam 4 is completely reflected, thereby striking photopolymer piece 3c designed for coupling, and then propagates in waveguide 22 back to transmission/receiving region 24. Detection region 25 is located in the center relative to coupling elements 3b and 3c.

An axis-type rain sensor is shown in FIGS. 5 and 6. As with the U-type, the fundamental measurement principle is based on the weakening of the total reflection of light beam 4 by rain drops located in detection region 25.

Optical waveguide 22 is located in a pane 26. Two photopolymer pieces 3d1, 3d2 designed for coupling and decoupling are located one in front of the other along the direction of propagation in optical waveguide 22, so that radiation 4 propagates in optical waveguide 22 to first photopolymer piece 3d1 (see FIG. 6), where a portion of radiation 4 is decoupled, is completely reflected at a detection region 25 on the outside of pane 26, and is coupled by the grating of second photopolymer piece 3d2 back into optical waveguide 22, while the portion of radiation 4 reflected at first photopolymer piece 3d1 initially propagates further in optical waveguide 22, is decoupled at second photopolymer piece 3d2 and, after being completely reflected at detection region 25, is coupled by first photopolymer piece 3d1 back into optical waveguide 22.

The advantage of the axis-type sensor is that the precision and efficiency of the refraction at grating 3d1 is relatively uncritical, since the refracted and non-refracted portions of light beam 4 are incorporated in the detection. It is therefore only necessary to guarantee and/or optimize the precision of the refraction with regard for grating 3d2. Due to the propagation of light beam 4 along an axis, it is possible to use a relatively wide light beam 4, thereby resulting in an advantageous enlargement of detection region 25.

The generation of volume holograms in a photopolymer is shown in FIG. 7. According to the present invention, the holographic grating is inscribed in the photopolymer via photopolymerization. The generation starts in a first step 7a) by providing a mixture (solution) of a polymer matrix 6 and photosensitive molecules 5 (the two components have been schematically separated into vertical regions in FIG. 7 only to simplify the explanation). Photosensitive molecules 5 are partially polymerized in illuminated regions 8 by illuminating them with a spacially periodic pattern 7, i.e., using exposed 8 and unexposed regions 9. This is shown in FIG. 7b) as a depositing 10 of molecules 5 in regions of polymer matrix 6. Non-deposited molecules 11 and the newly formed copolymer composed of deposited, photosensitive molecules 10 and polymer matrix 6 generate a spacial grating, which is characterized by the spacial, i.e., area-wise modulations 12 (caused by distribution 10) and 13 (caused by distribution 11) of the refractive index. As shown in FIG. 7b), modulations 12 and 13 partially compensate for each other, thereby initially resulting in a relatively weakly defined interference pattern 14. Modulation 13 caused by non-deposited molecules 11 may be shifted toward the zero line via diffusion (relaxation), which is induced, e.g., via heating (illumination). Diffusion results in a homogenization of non-deposited molecules 11 with regard for their distribution in exposed regions 8 and unexposed regions 9 (see FIG. 7c), which is associated with a reduction or elimination of associated second modulation 13 of the refractive index, thereby making interference pattern 14, i.e., the desired grating, more pronounced.

To set interference pattern 14 (see FIG. 7d), the developed photopolymer may be illuminated with a halogen lamp 15 in a spacially homogeneous manner, thereby resulting in a hardening of the photopolymer, i.e., in a (spacially homogeneous) depositing of photosensitive molecules 5 and 11—which have not yet been deposited—on photopolymer matrix 6. Interference pattern 14 developed in 7b) and 7c) is retained, of course, and forms the desired volume hologram.

FIGS. 8a) through g) show a possible sequence of steps to manufacture a rain sensor with coupling elements made of photopolymer. In step 8a), a photopolymer layer 17 is applied to a planar, solid surface 18 by depositing the photopolymer from a supply container 16 onto surface 18 underneath it, which is moving at a constant relative speed. The result of this step is depicted in FIG. 8b). The photopolymer layer 17 is dried and removed from surface 18 (see FIG. 8c). The generation of volume holograms in the photopolymer using interfering light-waves 20 takes place in step 8e). Before the volume holograms are generated, however, photopolymer layer 17 is preferably separated into individual photopolymer pieces 3 using scissors (see FIG. 8d).

In step 8f), photopolymer pieces 3 are placed on waveguide core 1 of optical waveguide 22, e.g., they are glued thereon. They are then coated with a waveguide cladding material 2 that is essentially transparent and has a lower refractive index than does waveguide core 1. In step 8g), optical waveguide 22 equipped with photopolymer pieces 3 is installed in a pane with glass layers 23 and intermediate layer 21. The coating with a waveguide clad material 2 in step 8f) may be carried out advantageously by immersing waveguide core 1 equipped with photopolymer pieces 3 in a Teflon solution.

When optical waveguide 22 equipped with photopolymer pieces 3 is placed, together with an adhesive intermediate layer 21, between two glass layers 23, they are baked at temperatures typically above approximately 100° C. to produce a laminated glass pane. The heat acting on photopolymer pieces 3 during baking is used simultaneously for fixation via heat treatment within the framework of a generation of volume holograms carried out as depicted in FIG. 7, and in FIG. 7d) in particular. In this embodiment of the manufacturing method, the process of baking the pane is limited as to time (e.g., to 30 minutes) such that the volume holograms are not destroyed, which occurs if they are heated for too long. Although this embodiment is advantageous mainly with a polymer matrix 6 with a relatively low melting point, such as PMMA, it is possible to use a polymer matrix 6 with a high melting point, such as PMMI, which may be subjected to a standard baking process to form a laminated glass pane without endangering the volume holograms.

What is claimed is:

1. A rain sensor, for a motor vehicle in particular, with an optical waveguide that may be located in a pane, and which includes a waveguide core (1), a waveguide clad (2), and planar holographic coupling elements for coupling and decoupling radiation (4),
wherein
the coupling elements are formed of lamellar photopolymer parts (3) in which volume holograms are integrated, and wherein the photopolymer parts (3) are located between the waveguide core (1) and the waveguide clad (2).

2. The rain sensor as recited in claim 1,
wherein
the optical waveguide (22) provided with the photopolymer pieces (3) is located in a laminated glass pane, between a glass layer (23) and an adhesive intermediate layer (21).

3. The rain sensor as recited in claim 1,
wherein
the photopolymer includes a polymer matrix (6) composed of polymethylmethacrylate (PMMA).

4. The rain sensor as recited in claim 1,
wherein
the optical waveguide (22) is located in a pane, and the radiation (4) in the optical waveguide (22) propagates to a first photopolymer piece (3b), via which the radiation (4) is decoupled from the optical waveguide (22) and is redirected through a glass layer (23) of the pane to a detection region (25) on the outside of the pane, from which point the radiation (4) is completely reflected and is coupled by a second photopolymer piece (3c) back into the optical waveguide (22) and propagates further therein; both photopolymer pieces (3b, 3c) are located—with separation between them—in a line that extends perpendicularly to the direction of propagation in the optical waveguide (22) and parallel to the pane.

5. The rain sensor as recited in claim 4,
wherein
the detection region (25) on the outside of the pane is nearly equidistant from the two photopolymer pieces (3b, 3c).

6. The rain sensor as recited in claim 1,
wherein
the optical waveguide (22) is located in a pane, and two photopolymer pieces (3d1, 3d2) designed for coupling and decoupling are located one in front of the other along the direction of propagation in the optical waveguide (22), and the radiation (4) propagates in the optical waveguide (22) to the first photopolymer piece (3d1), where a portion of the radiation (4) is decoupled, is completely reflected at a detection region (25) on the outside of the pane, and is coupled by a second photopolymer piece (3d2) back into the optical waveguide (22), while the portion of radiation (4) reflected at the first photopolymer piece (3d1) initially propagates further in the optical waveguide (22), is decoupled at the second photopolymer piece (3d2) and, after being completely reflected at the detection region (25), is coupled by the first photopolymer piece (3d1) back into the optical waveguide (22).

7. A method for generating a volume hologram in a holographic coupling element composed of photopolymer for a rain sensor, in particular for a rain sensor as recited in claim 1, with the steps:
Provide a photopolymer composed of a polymer matrix (6) and photosensitive molecules (5),
Holographically expose the photopolymer according to a specified spacially periodic pattern (7) of exposed and unexposed regions (8, 9); via polymerization of a portion (10) of the photosensitive molecules (5), a first modulation (12) of the refractive index corresponding to the regions (8, 9) is formed, which is partially compensated for by a second modulation (13) of the refractive index formed by non-polymerized, photosensitive molecules (11),
Develop the exposed photopolymer by heating, the heating being carried out such that, due to a spacially homogenizing diffusion of photosensitive molecules (11) from the unexposed regions (9) into the exposed regions (8), the second modulation (13) is reduced or eliminated, and, therefore, an interference pattern (14) formed by the modulations (12, 13) is enhanced,
Set the interference pattern (14) via exposure and/or heat treatment, in order to thereby produce a volume hologram in the photopolymer.

8. A method for manufacturing a rain sensor as recited in claim 1,
with the steps:
Apply a photopolymer layer (17) onto a planar, solid surface (18) by depositing the photopolymer onto the surface (18) underneath it, which is moving at a constant relative speed,
Dry and remove the photopolymer layer (17) from the surface (18),
Produce volume holograms in the photopolymer; before or after which the photopolymer layer (17) is separated into the individual photopolymer pieces (3),
Place the photopolymer pieces (3) on the waveguide core (1) of the optical waveguide (22), then apply a coating of a waveguide cladding material (2) that is essentially transparent and has a lower refractive index than does the waveguide core (1),
Install the optical waveguide (22) equipped with the photopolymer pieces (3) in a pane.

9. The method as recited in claim 8, the coating with a waveguide cladding material (2) being applied by immersing the waveguide core (1) equipped with the photopolymer pieces (3) in a Teflon solution.

10. The method as recited in claim 8, with which the optical waveguide (22) equipped with the photopolymer pieces (3) is placed, together with an adhesive intermediate layer (21), between two glass layers (23); they are then baked at temperatures above approximately 100° C. to produce a laminated glass pane; the heat acting on the photopolymer pieces (3) during baking is used simultaneously for fixation via heat treatment within the framework of a generation of volume holograms carried out.
